(19) United States
(12) Patent Application Publication
(10) Pub. No.: US 2022/0374489 A1
(43) Pub. Date: Nov. 24, 2022

(54) SYSTEM AND METHOD FOR RANKING OBJECTS

(71) Applicant: NAVER CORPORATION, Seongnam-si (KR)

(72) Inventors: Till KLETTI, La Tronche (FR); Jean-Michel RENDERS, Quaix en Chartreuse (FR)

(21) Appl. No.: 17/655,049

(22) Filed: Mar. 16, 2022

(30) Foreign Application Priority Data
May 6, 2021 (FR) 2104801
Nov. 8, 2021 (EP) 21306565.9

(51) Int. Cl. G06F 16/9538; G06F 17/11

(52) U.S. Cl. CPC G06F 16/9538; G06F 17/11

(57) ABSTRACT

A computer-implemented method for ranking a set of objects includes: receiving a set of objects and a set of objective functions; defining a decision space using a permutohedron having n decision variables, where n is the number of objects to rank and where vertex coordinates of the permutohedron represent exposure associated with the corresponding rank; determining a Pareto-set for the set of objective functions; with a Pareto-optimal point in the Pareto-set, determining a distribution over rankings for the objects in the set using the decision space; selecting a sequence of rankings for the set of objects from the distribution over rankings in accordance with their proportions; and outputting the selected sequence of rankings.

### PRIORITY CLAIM AND REFERENCE TO RELATED APPLICATIONS

This application claims priority under 35 U.S.C. 119 from French Patent Application, Serial Number FR 2104801, filed May 6, 2021, which contents are hereby incorporated by reference.

This application further claims priority under 35 U.S.C. 119 from European Patent Application Number EP21306565, filed Nov. 8, 2021, which contents are hereby incorporated by reference.

### FIELD

A field of this invention is information retrieval and recommendation. More particularly, embodiments of the invention relate to computer-implemented methods and systems for fairly ranking objects that are retrieved.

### BACKGROUND

Generally, information retrieval and recommendation involve two stages. The first stage focuses on retrieving a candidate set of results and the second stage focuses on ranking the candidate set of results.

The candidate set of results may include search results (e.g., lists of links to documents from search results in response to a query) and recommendations (e.g., lists of Points-Of-Interest recommendations in response to an identified location, or lists of recommendations of songs in response to genre selection, etc.).

For instance, for information retrieval, a query may be input to a first-stage retriever, which processes the query (for example, based on relevance), and accordingly retrieves a set of documents. A second-stage or ranker (or reranker) then ranks the retrieved set of documents and outputs a ranked set of documents, which, for instance, can be equal to or fewer in number than the first set.

Users (e.g., content consumers) expect the most relevant results to have the highest exposure, whereas providers (e.g., content producers) seek to have a fair (or equitable) exposure to their content. Hence, when ranking the candidate set of results in the second stage, it is preferred that the ranking method balances between utility (which represents users who access the set of results) and fairness (which represents the providers who make up the set of results).

While some ranking methods exist that balance utility and fairness, their complexity is generally prohibitive to enable their use in any realistic scenario. Hence, there continues to be a need for an optimal method (e.g., capable to compute exact optimal solutions) which complexity is reduced compared to existing methods so as to enable Web-scale fair-useful ranking, for instance.

### SUMMARY

Example methods of the present invention provide according to a first aspect a computer-implemented method for ranking a set of objects that includes:

receiving the set of objects and a set of objective functions;

defining a decision space having n decision variables using a permutohedron, where n is the number of objects to rank and where vertices of the permutohedron represent permutations of exposures provided to the objects in the set by corresponding rankings;

determining a Pareto-set for the set of objective functions;

with a Pareto-optimal point in the Pareto-set, determining a distribution over rankings for the objects in the set using the decision space, where a proportion is associated to each ranking in said distribution;

selecting a sequence of rankings for the objects in the set from the distribution over rankings in accordance with their proportions; and

outputting the selected sequence of rankings.

Certain preferred, but non-limiting aspects of the method according to the first aspect are as follows:
the set of objective functions may comprise a quadratic function and a linear function;
the quadratic function may be a fairness function and the linear function may be a utility function;
the fairness function may be a normalized difference, such as squared L2-norm of the difference, between a vector made up of the decision variables and a target vector;
the method may further comprise receiving a relevance score for each object in the set, a list of exposures provided to the objects in the set which are each associated with a rank, a ranking fairness objective function and a ranking utility objective function;
determining the Pareto-set for the set of objective functions may comprise computing the Pareto-set within the decision space considering the ranking fairness objective function and the ranking utility objective function, and wherein determining the distribution over rankings for the objects in the set using the decision space may comprise receiving a specified point in the Pareto-set which translates to a target exposure across the objects in the set within the decision space, and, using the target exposure, determining a distribution over rankings which achieve on average the target exposure for the objects in the set, each ranking of the distribution over rankings corresponding to a vertex in the decision space;
said determining the distribution over rankings for the objects in the set using the decision space may further comprise for the number of objects in the set:

(i) determining an arbitrary vertex of the decision space;

(ii) drawing a line starting at the arbitrary vertex through the target exposure until the line intersects a face of the decision space;

(iii) repeating (i) and (ii) on the intersected face of the decision space using the new intersection point instead of the target exposure, until the newly intersected face is a vertex;
the fairness function may be based on Meritocratic fairness or Demographic fairness;
determining the distribution over rankings for the objects in the set using the decision space may use a Grotschel, Lovasz and Schrijver (GLS) procedure;
selecting a sequence of rankings for the objects in the set may comprise one or more of stochastic sampling, Low-Discrepancy Sequences, additive-recurrence sequences, Stride Scheduling, or m-balancing;
the objects in the set may comprise a plurality of queries;
the objects in the set may be identified in response to a query;
the objects in the set may comprise a plurality of recommendations;
the objects in the set may be identified in response to a map location;
outputting may comprise providing for display on a display of a device at least a subset of the set of objects, ranked according to the selected sequence of rankings;
the at least a subset of the set of objects may be provided on a Search Engine Result Page.

According to a second, a third, a fourth, and a fifth aspect, respectively, the invention may provide: a computer program product comprising code instructions which, when said program is executed on a computer, cause the computer to perform the method according to the first aspect of the invention; a computer-readable medium having stored thereon the computer program product; a data processing device comprising a processor configured to perform the method according to the first aspect of the invention; and/or a system for information retrieval including a computer-implemented first-stage retriever configured to receive a query and generate a set of objects, and a computer-implemented second-stage ranker configured to rank the set of objects according to the first aspect of the invention.

### BRIEF DESCRIPTION OF THE DRAWINGS

The accompanying drawings are incorporated into the specification for the purpose of explaining the principles of the embodiments. The drawings are not to be construed as limiting the invention to only the illustrated and described embodiments or to how they can be made and used. Further features and advantages will become apparent from the following and, more particularly, from the description of the embodiments as illustrated in the accompanying drawings, wherein:

FIG. 1 illustrates an example of architecture in which the disclosed methods may be performed;

FIG. 2 illustrates a flow diagram setting out an embodiment of the disclosed method;

FIG. 3 illustrates an example permutohedron for n=4;

FIG. 4 illustrates a procedure for decomposing a point in the permutohedron into a combination of at most n of the permutohedron's vertices;

FIG. 5 illustrates an example generalized permutohedron (which is referred to in example methods as an Expohedron) for n=3,

FIG. 6 sets out pseudo code of an example decomposition method that can be employed in some methods;

FIG. 7 illustrates equi-utility curves and max-utility solution in the Expohedron (n=3);

FIG. 8 illustrates max-utility solution in the Expohedron with Relevance Ties (n=3);

FIGS. 9 and 10 illustrate optimal demographic and meritocratic fairness solutions and equi-fairness curves in the Expohedron (n=3);

FIG. 11 illustrates a Pareto-set in the Expohedron (n=3); and

FIG. 12 sets out pseudo code for an example Pareto-set identification method.

### DETAILED DESCRIPTION

### Architecture

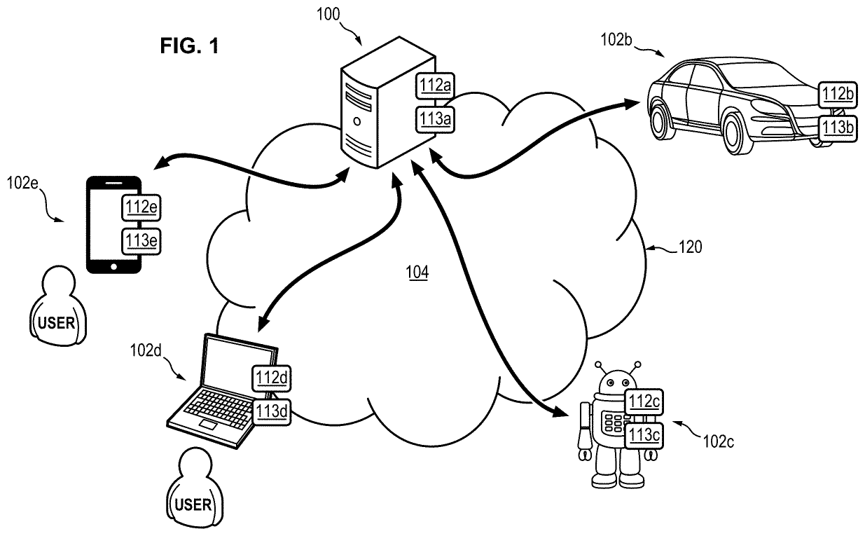

The disclosed computer-implemented method and embodiments for ranking objects may be implemented within an architecture (e.g., a network or system architecture) such as illustrated in FIG. 1, which comprises server 100 and one or more client devices 102 that communicate over a network 104 (which may be wireless and/or wired) such as the Internet for data exchange. Server 100 and the client devices 102 include a data processor 112 and memory 113 such as but not limited to random-access memory (RAM), read-only memory (ROM), hard disks, solid state disks, or other non-volatile storage media. Memory 113 may also be provided in whole or in part by external memory or storage in communication with the data processor 112. The client devices 102 may be any device that communicates with server 100.

Example methods provided herein may be implemented by a processor such as the processor 112 or other processor in the server 100 and/or client devices 102. It will be appreciated that the processor 112 can include either a single processor or multiple processors operating in series or in parallel. Memory used in example methods may be embodied, for instance, in memory 113 and/or suitable storage in the server 100, client devices 102b-e, a connected remote storage, or any combination. Memory can include one or more memories or memory elements or structures, including combinations of memory types and/or locations. Data in memory can be stored in any suitable format for data retrieval and processing.

Server 100 may include, but is not limited to, dedicated servers, cloud-based servers, or a combination (e.g., shared). Data streams may be communicated from, received by, and/or generated by the server 100 and/or the client devices 102b-e.

Client devices 102b-e may be any processor-based device, terminal, etc., and/or may be embodied in a client application executable by a processor-based device, etc. Client devices may be disposed within the server 100 and/or external to the server (local or remote, or any combination) and in communication with the server. Example client devices 102b-e include, but are not limited to, autonomous vehicle 102b, robot 102c, computer 102d, mobile communication devices (e.g., smartphones, tablet computers, etc.) such as smartphone 102e, as well as various processor-based devices not shown in FIG. 1 such as but not limited to virtual reality (VR), augmented reality (AR), or mixed reality (MR) devices, wearable computers, etc. Client devices 102b-e may be, but need not be, configured for sending data to and/or receiving data from the server 100, and may include, but need not include, one or more output devices, such as but not limited to displays, speakers, printers, etc. for displaying, announcing, or printing results of certain methods that are provided for display by the server. Client devices may include combinations of client devices.

### Method for Ranking a Set of Objects

Example methods provided herein address the problem of designing optimal fair-useful ranking policies efficiently using a set of optimization/decision variables. A first feature of example methods chooses as optimization/decision variables “item exposure” variables that act as key links between important objectives in what constitutes an ideal ranking: in particular a utility objective, which represents typically the user or consumer viewpoint, and a fairness objective, which represents typically the provider or supplier viewpoint.

Advantageously, a second feature of example methods can express the optimization problem with only n decision variables in a decision space which is (e.g., can be represented by) a generalized permutohedron, where n is the number of objects to rank, while keeping the expressiveness of the policy to fully control the utility and fairness objectives separately and exactly. Vertices of example permutohedrons disclosed can represent the exposure associated with a corresponding rank, and such permutohedrons are referred to herein as “Expohedrons”. The decision space provided by the permutohedron (e.g., Expohedron) allows one to represent any distribution (or convex combination) over rankings (or, synonymously, over permutations) and to reason geometrically in this space to solve the Utility-Fairness trade-off. In particular, the whole Pareto set of the MOO (Multi-objective Optimization) problem can be easily obtained without passing through explicit scalarisation techniques, thus reducing required processing time and resources.

Example methods can determine the optimal policy using unbiased estimates of relevance scores with uniform estimation quality over the objects and an exposure model with known structure and parameters.

Example methods operate with a complexity of O(n² log n). Such methods can apply geometric reasoning. Most of the method's steps may be expressed in closed-form equations. Other of the method's steps can be provided by sorting operations. Moreover, the entire Pareto-set can be generated analytically and geometrically, without relying on, say, a scalarization technique to scan the entire frontier.

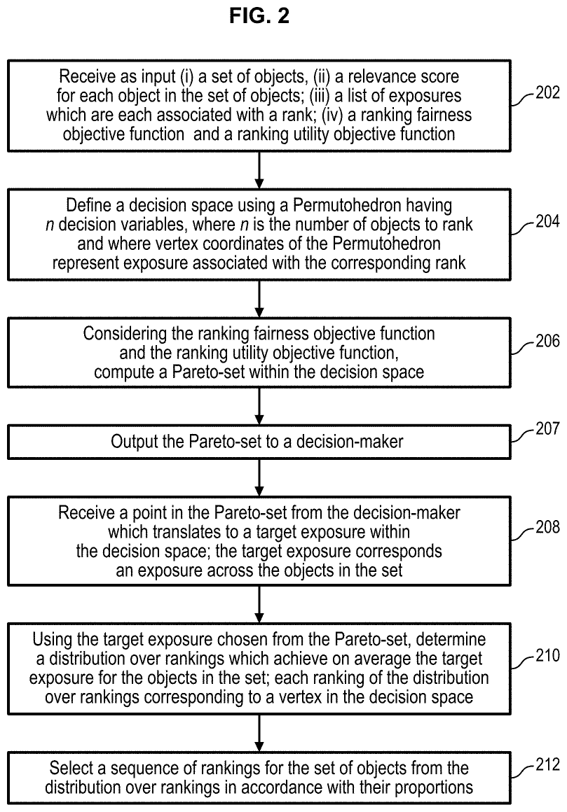

FIG. 2 illustrates a flow diagram setting out an embodiment of the disclosed methods for ranking a set of objects. The method according to the embodiment of FIG. 2 may be performed at server 100, and the example method is described with respect to server 100. However, it will be appreciated that the method can likewise be performed by client 102, or by a combination of server 100 and client 102.

At 202, server 100 receives from any suitable source(s), including external and/or internal sources, a set of objects, an (e.g., unbiased) relevance score for each object in the set of objects, a list of exposures which are each associated with a rank, and objective functions including a ranking fairness objective function and a ranking utility objective function. At 204, server 100 defines a decision space using a permutohedron having n decision variables, where n is the number of objects to rank and where vertices of the permutohedron represent permutations of exposures provided to the objects in the set by corresponding rankings.

At 206, using the ranking fairness objective function and the ranking utility objective function, server 100 computes a Pareto-set (i.e., the set of non-dominated solutions where there are no other solutions that are better for all objective functions; for example, where there are no exposures that offer larger utility and better fairness at the same time) within the decision space defined by the list of exposures between a first point representing optimal fairness and a second point representing optimal utility. Optimal fairness types in example methods may include, for instance, demographic fairness and meritocratic fairness. As described in more detail below, the ideal exposure for demographic fairness allows equal exposure, whereas for meritocratic fairness exposure may be defined based on relevance (e.g., defined using a vector of relevance). In yet other embodiments, the optimal fairness type may be additionally or alternatively customized based on a defined proportion other than fairness (e.g., for allocating prize money to be paid).

Example fairness types consider individual fairness as opposed to group fairness. Individual fairness tries to ensure equity at the level of individual objects, while group fairness assumes that objects can be related to groups and that the equity is ensured at the group level, typically preventing some minority group to be disadvantaged.

At 207, the server 100 outputs (internally or externally) the Pareto-set to a decision-maker. At 208, server 100 receives (internally or externally) a point in the Pareto-set which translates to a target exposure within the decision space. This target exposure corresponds to an exposure across the objects in the set. The target exposure in an embodiment may be defined by a decision-maker internal or external to the server 100 that sets a defined utility/fairness trade-off, which could be set on a case-by-case basis or more generally as fixed constraints (e.g., set constraints where fairness does not fall below a predefined threshold). In some embodiments the decision-maker may be an administrator. In other embodiments the decision-maker may be an automated system. Combination of administrators and automated systems may also be used.

At 210, using the target exposure received from the decision-maker as an optimal trade-off in the Pareto-set, server 100 determines a distribution over rankings (e.g., a weighted set of rankings) which achieve on average the target exposure for the objects in the set, where each ranking of the distribution over rankings corresponds to a vertex in the decision space. In one embodiment, determining the distribution over rankings can be performed as follows: (i) an arbitrary vertex of the decision space is determined; (ii) a line is drawn (e.g., computed) starting at the arbitrary vertex through the target exposure received from the decision-maker until the line intersects a face of the decision space; (iii) the steps (i) and (ii) are repeated on the intersected face of the decision space using the intersection point instead of the decision-maker's target exposure, until the newly intersected face is a vertex. Steps (i)-(iii) can be performed as many times as there are objects in the set, depending on when the intersection is a vertex at step (iii). Each vertex of the decision space has an associated proportion.

At 212, server 100 deploys the distribution over rankings by selecting a sequence of rankings for the set of objects from the distribution over rankings in accordance with their proportions.

In other embodiments, as mentioned above, the method according to the embodiments of FIG. 2 may be performed at client device 102 partially or completely. In yet other embodiments, the method may be performed at a different server or client devices or on a plurality of servers in a distributed manner.

In one exemplary embodiment, a non-personalized query (e.g., a query made by an anonymous user) is received repeatedly for general points of interest at a defined map location. The set of objects in this exemplary embodiment may be a list of general points of interest such as restaurants, museums, shops, and gas stations. In another exemplary embodiment, a non-personalized keyword query is received repeatedly by a search engine. The set of objects in this exemplary embodiment may be a list of links to documents such as web pages. As these queries are repeated over time, the ordering of the sets of objects varies in accordance with their respective sequence of rankings to achieve their target exposure.

Based on the selected sequence of rankings at 212, one, all, or a subset of the set of objects can be presented, e.g., in a Search Engine Result Page (SERP) that is prepared and provided, e.g., transmitted, to an external or internal device for presenting (e.g., displaying, announcing, printing, importing, exporting, storing, etc.). For instance, a SERP including one, a subset, or all of the objects, where such objects are respectively located based on their determined rank within the selected sequence, can be generated and transmitted to a terminal of a server 100 or client device 102 for displaying on a display. If one or a subset of the objects are presented in the SERP instead of all objects, such presented objects may be, for instance, those objects having a respectively higher ranking in the selected sequence than others in the set of objects.

### Exposure

Exposure, also known as “attention” or “examination” in the field of Information Retrieval (IR), can be defined as the probability that the user will examine an object (such as but not limited to a document) in a certain location of a Search Engine Result Page (SERP). Exposure values (e.g., forming part of the list of exposures received at step 202(iii) in FIG. 2) can be captured by methods such as but not limited to eye-tracking studies or by interventional harvesting (e.g., by putting the same document for the same query at two different ranks). The exposure values may also be determined by methods employing “click models” (i.e., user browsing models) as will be appreciated in the art of Information Retrieval (e.g., as disclosed in Chuklin et al., “Click models for web search”, published in Synthesis Lectures on Information Concepts, Retrieval, and Services, 7(3):1-115, July 2015). Most of the time, these models try to explain the click behavior by a natural sequence of two steps: first examine (or turn one's attention to) an item or its representative snippet, then click on it, if it looks attractive.

From the consumer's (i.e., user's) viewpoint, the consumer desires the more relevant objects be given a higher exposure, so as not to spend time looking for relevant objects in a poorly visible location of the SERP. This desire by the consumer may be expressed in example methods by defining the utility of a ranking as the dot product between an exposure vector (i.e., the vector made up of the exposure values provided by the ranking to each object) and a gain vector (i.e., the vector made up of the gains of each object, the gain of an object being defined by an arbitrary monotonically increasing function of the relevance score of the object). Known information retrieval utility measures such as but not limited to Discounted Cumulative Gain (DCG) and Expected Reciprocal Rank (ERR) reflect this formulation, with particular choices of the exposure model parameters. DCG, for instance, assumes that the exposure of an object at rank k is given by 1/log₂(1+k) and that the gain function g(d) is given by g(d)=2^{rel(d)}, where rel(d) is the relevance score of d. The ERR measure is based on the cascade model and assumes that the exposure depends on the relevance of previous objects in the list; in particular, once a user is satisfied with an object, the exposure of the next objects in the list will be zero.

From a provider's viewpoint, the provider would like that their own objects have a higher exposure in the SERP. However, because there are many providers, a non-disparate treatment of the objects presented to users is desired.

Both the consumer's and the provider's viewpoints, which correspond respectively to a “Utility” objective and “Fairness” criteria, can be expressed in example methods disclosed herein in terms of “exposure.” Exposure acts as a link between objectives of an ideal ranking: the utility objective (e.g., which represents the user or the consumer viewpoint) and the fairness criterion (e.g., which represents the object provider or supplier viewpoint).

### Permutohedron

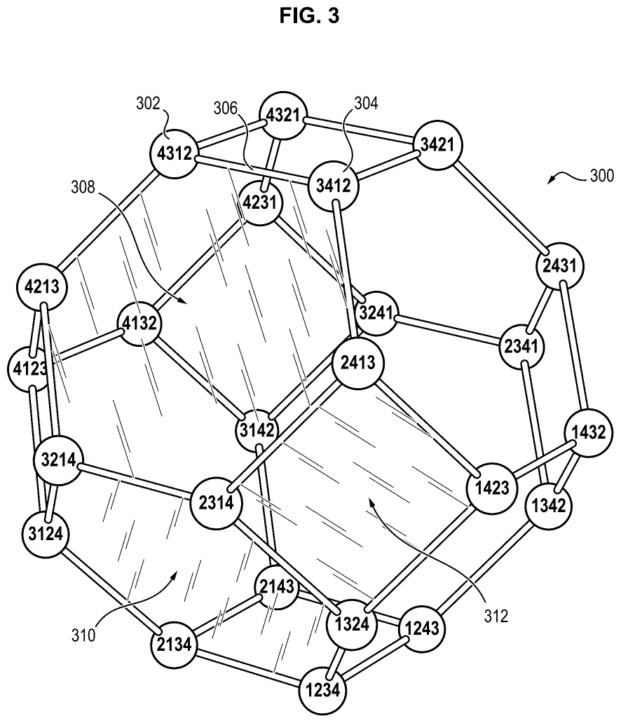

An example permutohedron is a polytope, where each vertex corresponds to a particular ranking or permutation over n objects (e.g., documents) and the polytope is the convex hull of these vertices. This polytope is embedded in an n-dimensional space, but is actually (n−1) dimensional. For example, FIG. 3 represents, for n=4 objects, a 3-D object 300, which looks somewhat like a ball with a mix of hexagonal and squared facets. Consider the vertex (4 3 1 2) at 302: it represents a ranking that puts d₁ at rank 4, d₂ at rank 3, d₃ at rank 1 and d₄ at rank 2. Consider further the edge 306 linking the vertices (4 3 1 2) at 302 and (3 4 1 2) at 304: it represents any distribution (or convex combination) over the two rankings.

In addition, every facet of the 3-D object 300 represents a partial ordering of the n objects into two groups. For example, the facet 308 including vertices (4 3 1 2), (3 4 1 2), (2 4 1 3), (2 3 1 4), (3 2 1 4), and (4 2 1 3) represents a partial ordering where d₃ is always first (i.e., d₃@rank 1) followed by the three other documents in any order; the facet 310 including vertices (3 2 1 4), (2 3 1 4), (1 3 2 4), (1 2 3 4), (2 1 3 4), and (3 1 2 4) represents a partial ordering where d₄ is always last (i.e., d₄@rank 4) preceded by the three other documents in any order; and the squared facet 312 including vertices (2 4 1 3), (1 4 2 3), (1 3 2 4), and (2 3 1 4) represents a partial ordering where d₁ and d₃, in any order for the first two positions, followed by d₂ and d₄, in any order for the last two positions (i.e., (d₁ and d₃) before (d₂ and d₄)).

More generally, each face of dimension (n−k), which generalizes the notion of facet by following a hierarchy with decreasing dimensionality (e.g., facet→edge→vertex for n=4) represents all possible distributions (or convex combinations) respecting a certain partial ordering of the n objects into k groups. Referring again to FIG. 3, the edge 306 linking the vertex (4 3 1 2) at 302 and the vertex (3 4 1 2) at 304 corresponds to the partial order: d₃ first, d₄ second, followed by d₁ and d₂ in any order.

### Decomposition

Caratheodory's theorem states that any point in the convex hull of a set P of m points vᵢ, embedded in a d-dimensional space (vᵢ∈by R^{d} ∀i=1, . . . , m) can be decomposed into a convex combination of at most (d+1) of these points.

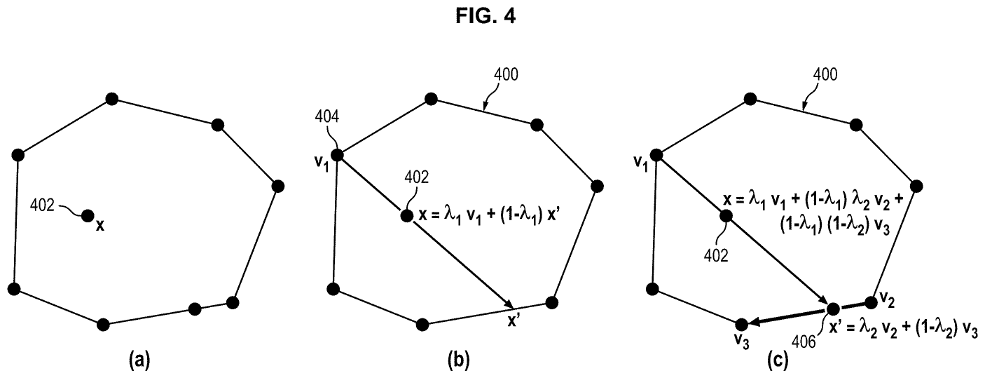

When the permutohedron is considered as a special case, any point of the permutohedron, which is a d-dimensional object with d=(n−1) (n designating the number of objects), can be decomposed into a distribution over at most n rankings. In an embodiment a procedure known as the GLS procedure (Grotschel, Lovasz and Schrijver) can be used to determine one such decomposition (in general, more than one single decomposition is possible). An example of the GLS procedure (see Grotschel et al., “Geometric Algorithms and Combinatorial Optimization,” published in Springer Science & Business Media, December 2012) is illustrated in FIG. 4 for an n=3 polytope as it is applied to the methods disclosed herein.

FIG. 4(a) shows a point x to be decomposed at 402. As shown in FIG. 4(b), the procedure starts by choosing any vertex v₁ at 404 of the polytope 400 (n=3) and extending the line segment going from v₁ to x (the point 402 to be decomposed) until intersecting a face of dimension (n−2). This gives a new point x′, where x can be expressed as a convex combination of v₁ and x′ (i.e., x=λ₁v₁+(1−λ₁)x′).

As shown in FIG. 4(c), the point x′ on the (n−2)-dimensional face can itself be decomposed by the same procedure by choosing any vertex belonging to the face of x′ (referred to as v₂) and extending the line segment v₂−x′ until it intersects with a face of dimension (n−3). In the example case shown in FIG. 4(c), n=3 so that this face is a vertex (v₃) and the procedure stops at this point: the initial point x is now expressed as the convex combination of three vertices (i.e., x=λ₁v₁+(1−λ₁)λ₂v₂+(1−80 ₁)(1−λ₂)v₃). In general, with higher values of n, these recursive steps are repeated, each time considering a face of decreasing dimension until reaching a face of dim 0 (i.e., a vertex).

### Notation

Example ranking methods set forth herein will now be described in further detail. The following notation is used for the purpose of formally describing features of example methods:
a) q is a query, which may be repeated an indefinite number of times by a single (e.g., anonymous) user (such as a consumer); it is noted that the query is not necessarily a textual query in the usual ‘Information Retrieval’ sense but should be understood in a broad sense; for instance, the query can also include any triggering context in a “Recommendation” setting.
b) for query q, there is a fixed candidate set of n objects (e.g., documents, Points-of-Interest (POI), recommendations, etc.), D=(d₁, . . . , dₙ), whose relevance scores with respect to query q are denoted as ρ=(ρ₁, . . . , ρₙ); and
c) A ranking policy π(q) is a distribution (such as a convex combination) over m rankings with m≤n σᵢ (i=1, . . . , m): π(q)=Σᵢ₌₁^{m}αᵢσᵢ where each ranking σᵢ maps each object dⱼ to a rank σᵢ(dⱼ). Using a distribution on at most n rankings (m≤n) is a consequence of the Caratheodory's theorem in the permutohedron as used in example methods. As described in more detail below, ranking policy π(q) can be deployed as a sequence of rankings that is as close as possible to the proportions given by the αᵢ coefficients. The goal is to find a set of policies π*(q) which are optimal with respect to a multi-objective optimization problem including utility and fairness criteria.

### Ranking Policy Optimization

Example methods can use a ranking policy, denoted herein as π(q), that is both useful and fair by expressing everything (e.g., consumer-oriented utility and provider-oriented fairness) in terms of a single set of decision/optimization variables, which variables are referred to herein as “control levers.” The control levers define an exposure vector, denoted as └_{π(q)}. This vector is indexed by object (the first component corresponds to document d₁, etc.). This means that, instead of working directly in a decision space defined using a permutohedron where vertex coordinates represent ranks, a modified polytope, referred to herein as an Expohedron, can be used by the disclosed method, where vertex coordinates represent the exposure associated with the corresponding rank. In other words, vertices of the Expohedron represent permutations of exposures provided to the objects by corresponding rankings. While there can exist a 1:1 correspondence between the permutohedron and the Expohedron, the Expohedron directly represents the control lever space (i.e., decision space). Referring again to the exposure vector, denoted as ∈_{π(q)}: the ranking policy is a distribution over m rankings maximum (m≤n), ∈_{π(q)}Σᵢ₌₁^{m}αᵢ∈_{σ}_{ᵢ}, where ∈_{σ}_{ᵢ} is the vector of exposures that the ranking σᵢ is offering to the objects.

This optimization problem may be expressed as a multi-objective optimization problem. A Pareto-set (i.e., the set of feasible non-dominated solutions) can be determined by geometric reasoning. Then, a particular trade-off in this determined Pareto-set can be selected or determined, e.g., by a decision-maker, where the trade-off is one target point in the decision space (i.e., a target exposure). This point can be decomposed as a convex combination of at most n rankings, as known from Caratheodory's theorem as provided above.

Once this combination is determined, it (i.e., the ordering of a set of objects from the distribution over rankings) may be deployed through a fair scheduling strategy, which in one embodiment uses low-discrepancy sequences, such as the golden-ratio low-discrepancy sequences (see “Weighted Round Robin (Weighted Random Integers) Using the Golden Ratio Low Discrepancy Sequence”, published on the Internet at demofox.org, June 2020). Those skilled in the art will appreciate that other scheduling strategies could be used in alternate embodiments such as but not limited to algorithms similar to m-balanced words or, equivalently, Stride Scheduling.

An advantage of example methods is that several or even most steps may be performed using geometric reasoning, which in practice, leads to simple algebraic, closed-form solutions. A further advantage of example methods is that they offer a time complexity in O(n² log(n)). Yet a further advantage of example methods is that they operate in an n-dimensional space, instead of, for instance, an n!-dimensional space or an n²-dimensional space. Consequently, the number of decision/optimization variables employed by example methods is not larger than n, allowing any optimal solution as a distribution over only n rankings at maximum to be implemented.

Example methods can be provided for a general class of exposure models referred to as a “Position-Based Model” (PBM). This family of models assumes that the exposure of an object only depends on its rank. Each rank k is then associated with a parameter γₖ which represents the probability that this rank will be examined by the user. Other classes of models may be processed using example methods.

### Expohedron Associated With the PBM Model

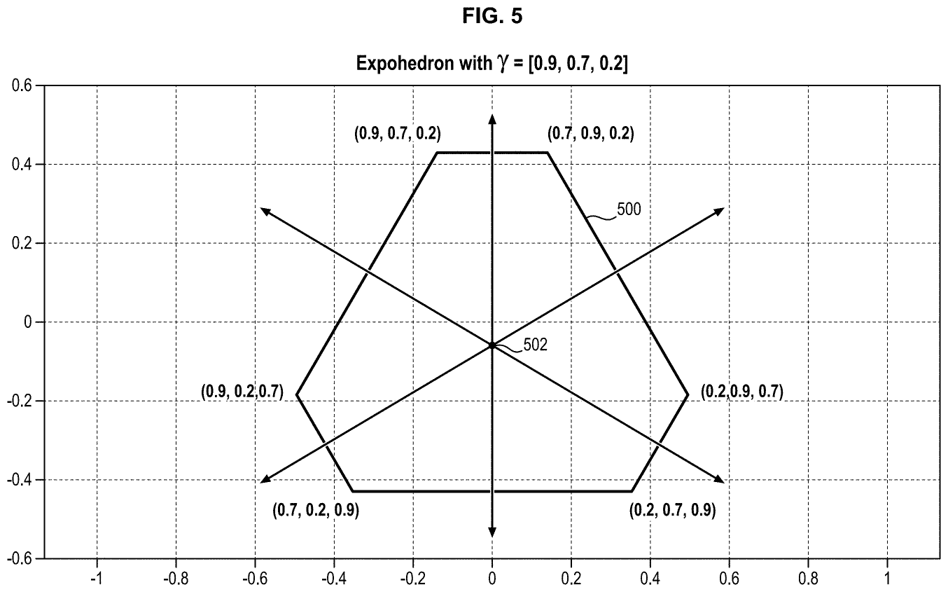

In embodiments, an example method uses a PBM-type exposure model, characterized by a fixed set of n parameters γ=(γ₁, y₂, . . . , γₙ). Without loss of generality, it is assumed that the γₖ are sorted by decreasing value. This does not necessarily imply that the examination probabilities are decreasing with the rank, even if it often is the case in practice. Under this model, the sum of object (e.g., document) exposures in a ranked list is always the same and equal to Σₖ₌₁ⁿγₖ. A particular example of an Expohedron for n=3 is shown in FIG. 5. Because the total sum of exposures is a constant in the example method, the example Expohedron lies on a plane embedded in a 3D-space. FIG. 5 represents the projection on that plane.

Any point in the Expohedron shown in FIG. 5 represents a particular exposure vector and this vector can be realized by a distribution of, maximum, three different permutations or rankings. The barycenter 502 of the hexagon 500 corresponds to equal exposure (i.e., demographic fairness) to each object (e.g., document), and can be realized as the uniform distribution over only three different rankings.

There is a straightforward mathematical way to check whether a point belongs to the Expohedron, and this way is exploited by example methods as explained herein. This is referred to as the majorization condition in mathematics, which provides that a point ∈=(∈₁, . . . , ∈ₙ) belongs to the Expohedron if and only if ∈ is majorized by γ, which is written as : ∈ [symbol] γ.

The mathematical definition of majorization is the following: ∈ [symbol] γ iff: Σᵢ₌₁^{k}∈ᵢ^{↓}≤Σi=1^{k}γᵢ^{↓}∀k<n and Σᵢ₌₁ⁿ∈ᵢ^{↓}=Σi=1ⁿγᵢ^{↓} with x↓ the vector with the same components as x, but sorted in descending order.

“Zones” as used herein are defined as sets of points that have coordinates (i.e., exposures) in the same order. More particularly, these points can correspond to vectors such that the indices of the components sorted in increasing order are the same. In python, for example, it corresponds to arrays for which the outputs of the argsort function are identical. There are as many zones as vertices in the Expohedron, and each zone contains only one vertex. An example zone is an unbounded pyramid, whose apex is the barycenter and whose semi-axes correspond to the lines joining the Expohedron barycenter to the barycenter of each facet adjacent to the unique vertex that the zone contains.

Given a point in the Expohedron decision space, which has coordinates given by ∈_{π(q)}, an example method can include and/or consider the following, each of which is illustrated in further detail respectively in the sections that follow:
Define the Utility of a ranking policy π(q) in this decision space;
Define different Fairness measures for ranking policies in this decision space;
Determine the Pareto-set (the set of non-dominated policies) corresponding to the Multi-Objective Optimization (MOO) problem, balancing Utility and Fairness;
Decompose a particular choice of a target exposure by the decision-maker on this Pareto-set as a distribution over at most n rankings; and
Deploy a distribution over at most n rankings with an efficient and effective scheduling strategy.

### Utility in the PBM-Expohedron

The example Utility criterion provides that objects with high relevance score or, more generally, with high gain should have a higher exposure. Without loss of generality, ρ is defined as the vector of the gains (or relevance scores, if the gain function is chosen as the identity), normalized in the same units as the exposure vector, in the sense that Σᵢ₌₁ⁿρᵢ=Σᵢ₌₁ⁿγᵢ, which is a constant for a given PBM. This implies that ρ is located on the same hyperplane as the exposure vectors and that they can be directly compared, composed or visualized jointly on the projected Expohedron.

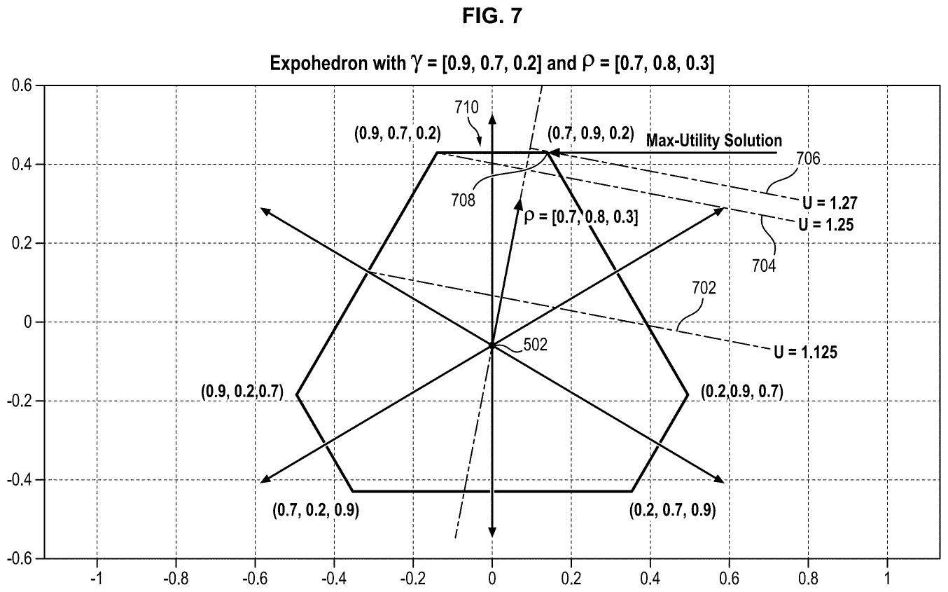

Utility may be expressed, for example, as the dot product between the relevance vector and the exposure vector: U(∈)=ρ^{T}.∈. Consequently, equi-utility surfaces in the Expohedron are hyperplanes whose normal is equal to ρ, as illustrated in FIG. 7 for hyperplanes 702, 704, and 706. This definition of Utility corresponds to the standard discounted cumulative gain (DCG) definition of Utility in Information Retrieval for a particular choice of the gain function as 2^{relevance} and of the exposure parameters, namely:

$${γ}_{i} = \frac{1}{{log}_{2} ( i + 1 )} .$$

Given this mathematical expression of the Utility, the max-Utility ranking policy in the Expohedron may be found using the point ∈* (or in some example methods the set of points) located on a face of the Expohedron whose projection on the ρ, i.e.,

$$\frac{{( {∈}^{*} )}^{T} \cdot ρ}{‖ ρ ‖} ,$$

is the largest (see, for example, the point 708 on the face 710 in FIG. 7). It is not necessary to project all the points of the Expohedron to find this max-Utility ranking: it is the vertex that is located in the same zone as ρ, which necessitates a single sorting operation. This is an equivalent formulation to the Probability Ranking Principle in Information Retrieval (see Stephen Robertson, “The Probability Ranking Principle in IR”, in Journal of Documentation, 33:294-304, December 1977).

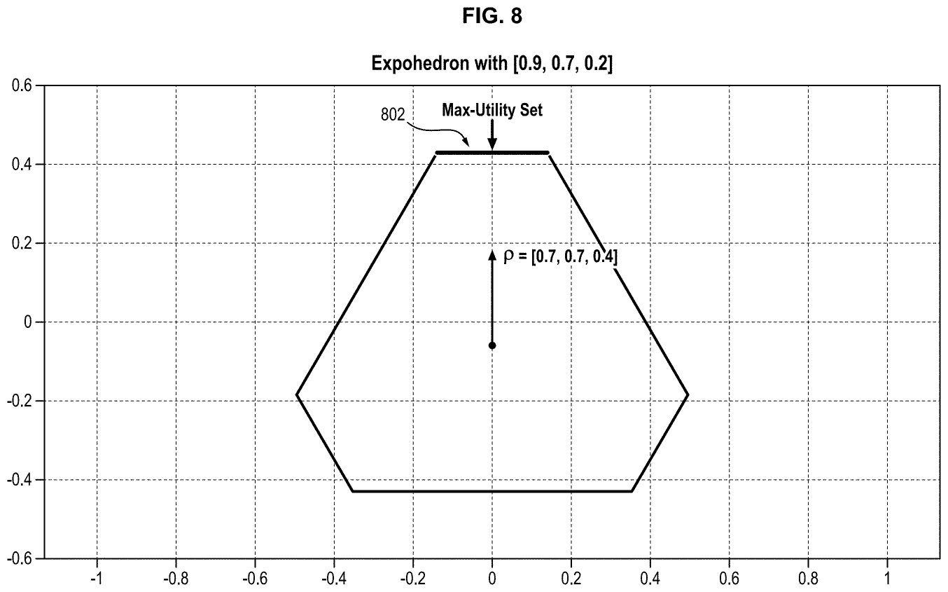

When the relevance vector has ties (i.e., where at least two elements of the relevance vector are equal), as represented on FIG. 8 with ties (as shown in the relevance vector <0.7,0.7,0.4>), the whole face 802 constitutes the set of max-Utility solutions.

### Fairness in the PBM-Expohedron

An example fairness criterion will now be expressed in the Expohedron framework. The individual Demographic fairness criterion states that, ideally, all objects (e.g., documents) should have the same exposure. As the sum of the exposures is a constant, it means that the target exposure of the Demographic fairness policy is the barycenter of the Expohedron:

$$β = ( \frac{{\sum }_{i = 1}^{n} {γ}_{i}}{n} , … , \frac{{\sum }_{i = 1}^{n} {γ}_{i}}{n} ) .$$

Thus, the fairness criterion can be defined as a quadratic function, for instance as the proximity (or minus the distance) to the barycenter: F_{d}(∈)=−∥∈−β∥₂².

Considering now Meritocratic Fairness, the ideal exposure vector should be proportional to the relevance vector or, more generally, to the merit vector denoted as ρ′, where the merit of an object is defined as a monotonically increasing function of the relevance score of this object or, equivalently, of its gain (the proportionality constant is equal to one here, when working with a merit vector normalized in the same units as the exposure vector, in the sense that Σᵢ₌₁^{nρ}ᵢ′=Σᵢ₌₁ⁿγᵢ). ρ and ρ′ are located in the same zone, because of the monotonically increasing relationship linking them. ρ and ρ′ may be, but need not be, chosen as equal, and identical to the relevance score vector (i.e., the gain and merit functions are chosen as the identity function). Formally, the Meritocratic fairness of a policy with exposure ∈ can be defined as a quadratic function, for instance as the proximity (or minus the distance) to the normalised relevance vector: Fₘ(∈)=−∥∈−ρ′∥₂².

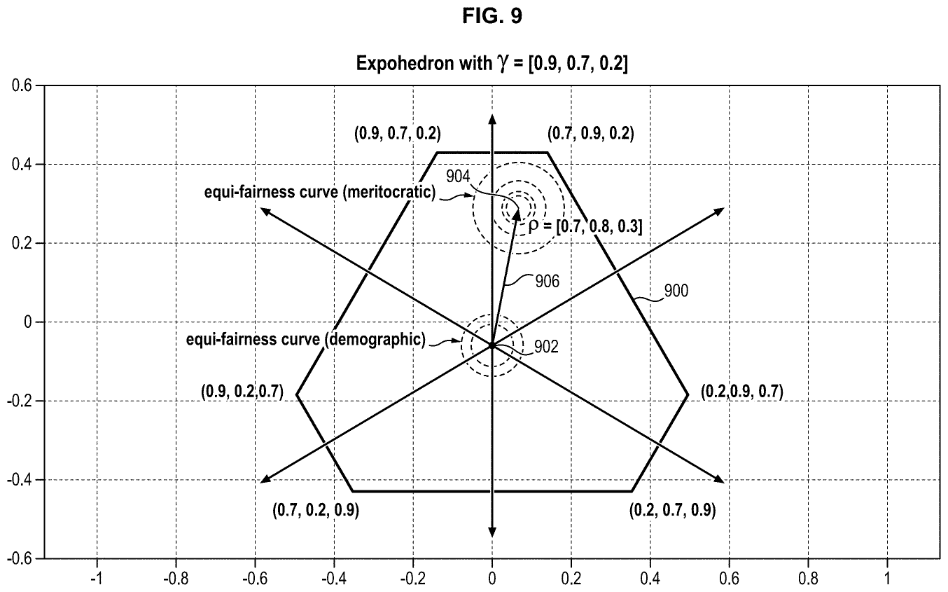

As illustrated in FIG. 9 where ρ and ρ′ are chosen as equal, equi-fairness surfaces are hyper-spheres centered around β or ρ, for Demographic fairness 902 and Meritocratic fairness 904, respectively, in the Expohedron (n=3) 900, the optimal Demographic and Meritocratic fairness equi-fairness curves are the circles that surround the optimal fairness points 902 and 904, respectively, where the vector 906 is the relevance vector.

It could happen that the merit vector is outside the Expohedron, namely when γ [symbol] ρ′ (i.e., the majorization condition is not fulfilled). In this case, it is possible to relax the pure proportionality relationship into an affine relationship, with an offset as small as possible while still being in the Expohedron (e.g., the definition of fairness as expressed in Biega et al., “Overview of the TREC 2019 Fair Ranking Track”, in arXiv:2003.11650, March 2020, and in Diaz et al., “Evaluating Stochastic Rankings with Expected Exposure”, in Proceedings of the 29th ACM International Conference on Information & Knowledge Management, pages 275-284, October 2020). This amounts to choosing a target vector which is at the intersection of the merit vector axis and the border of the Expohedron.

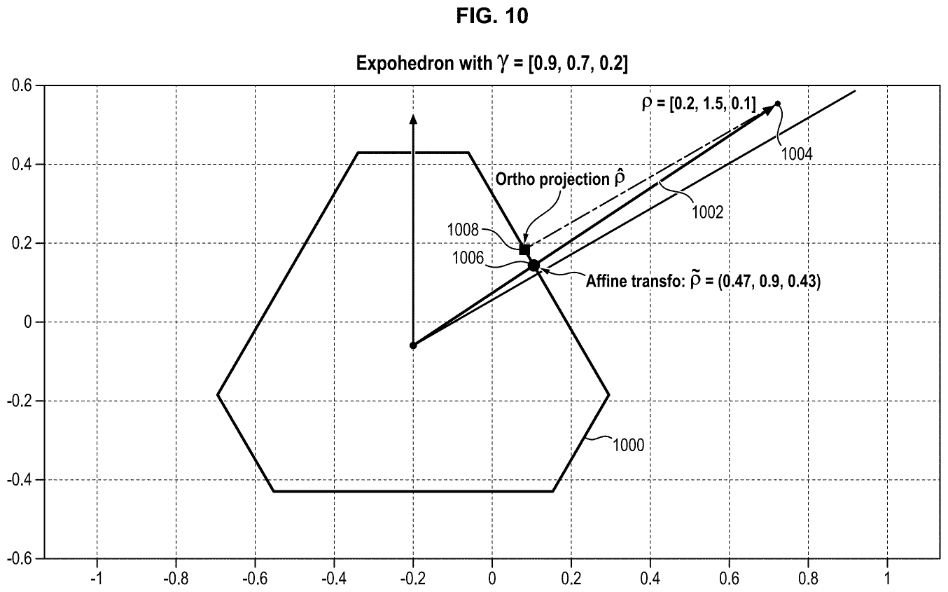

FIG. 10 shows an example in which the optimal point 1004 identified by the merit vector 1002 is unfeasible because it is outside the Expohedron 1000. This new feasible target vector is indicated at point 1006. This can be computed as follows:

Denote Gₖ=Σᵢ₌₁^{k}γᵢ and Rₖ=Σᵢ₌₁^{k}ρ′ᵢ^{↓}. The intersection of the relevance vector axis and the border of the Expohedron is given by the affine transformation (referred to in FIG. 10 as “Affine transform”) of the normalised merits \tilde{ρ}ᵢ=αρ′ᵢ+b, with:

$$b = {G}_{n} {max}_{k = 1 , 2 , … , n - 1} \frac{\frac{{G}_{k}}{{G}_{n}} - \frac{{R}_{k}}{{R}_{n}}}{k - n \frac{{R}_{k}}{{R}_{n}}} ,$$

which expresses that Σᵢ₌₁^{k}\tilde{ρ}ᵢ≤Σᵢ₌₁^{k}γᵢ, and that b is the smallest value that ensures that condition ∀k<n; and

$$a = \frac{{G}_{n} - n b}{{R}_{n}} ,$$

which expresses that Σᵢ₌₁ⁿ\tilde{ρ}ᵢ=Σᵢ₌₁ⁿγᵢ.

An alternative solution to the affine transformation for choosing an alternative but feasible meritocratic fairness point is to compute an orthogonal projection, for which a result for the example shown in FIG. 10 is indicated at point 1008.

### Pareto-Set in the PBM-Expohedron

Having determined how to compute and how to optimize the Utility and Fairness separately, the complete Pareto-set of the multi-objective Utility-Fairness Problem can be computed.

Explaining the method intuitively and geometrically, an example computation method starts from one extreme of the Pareto-set, namely the ‘purely fair’ solution. Then, to draw (e.g., compute) the entire Pareto-set, the gain vector direction is (computationally) followed. It may be shown that all these points are not dominated by any other point in the Expohedron and correspond to some optimal trade-off between fairness and utility. If the gain vector direction is always followed, the border of the Expohedron will necessarily be crossed at a certain point, which means that the solution is no longer feasible. The direction of the gain vector projected on the (n−2)-dimensional facet that was just crossed is then (computationally) followed. By following this new direction, a new face is crossed, which is this time (n−3)-dimensional, and, once again, the direction of the gain vector projected on that new face should be followed. Finding the projection of the gain vector of any face has a closed-form expression. This path-following procedure is re-iterated computationally until finally a non-dominated max-Utility solution is reached. Along that path, every point corresponds to a strongly non-dominated solution of the utility-fairness trade-off, in other words, the path is a Pareto-set.

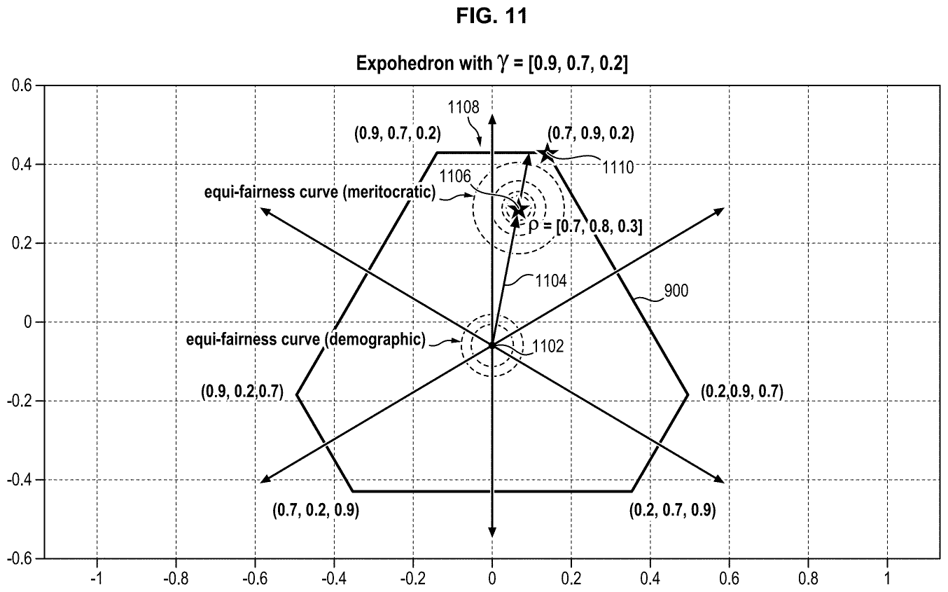

The path-following procedure described above is illustrated in FIG. 11 for n=3 and for gain and merit functions chosen as the identity (i.e., the merit and the gain of a document are identical to its relevance score). The Pareto-set is defined from 1102 to 1110 if the demographic fairness criterion is used, and from 1106 to 1110 if the meritocratic fairness criterion is used. The Pareto-set starts from the barycenter 1102 on the graph (if the demographic fairness criterion is used), and the direction of the line segment 1104 (which is the gain vector axis) is followed, which goes through the meritocratic fairness point 1106 on the graph, intersects the edge 1108, or the facet, that corresponds to mixing rankings where objects (e.g., documents) d₁ and d₂ are permuted in the first two ranks and then this facet is followed until the max-Utility solution is reached, represented as the star 1110 on the graph. If the meritocratic fairness criterion were used, the Pareto-set would start at point 1106.

More formally described, the Pareto-optimal set is the union of (n−1) line segments that connects ν⁽ⁱ⁻¹⁾ to ν⁽ⁱ⁾, for i=1, . . . , (n−1). In the following, without loss of generality and for the sake of notation simplicity, it is assumed that the objects (e.g., documents) are sorted by decreasing order of gain, namely ρ=(ρ₁, ρ₂, . . . , ρₙ) with ρ₁≥ρ₂≥ . . . ≥ρₙ. The initial point ν⁽⁰⁾ is either β or ρ′ (replaced by \tilde{ρ} if ρ′ is infeasible), depending on whether demographic or meritocratic fairness are considered. When establishing the Pareto-set, the points are always located in the same zone (i.e., the zone of the max-Utility or PRP vertex; it is noted that the barycenter belongs to all zones, as all zones have the barycenter as apex) because, the order of the components of the corresponding exposure vectors is not changed when a vector in the direction of the gain vector is incrementally added to these exposure vectors, even if it is projected on a face.

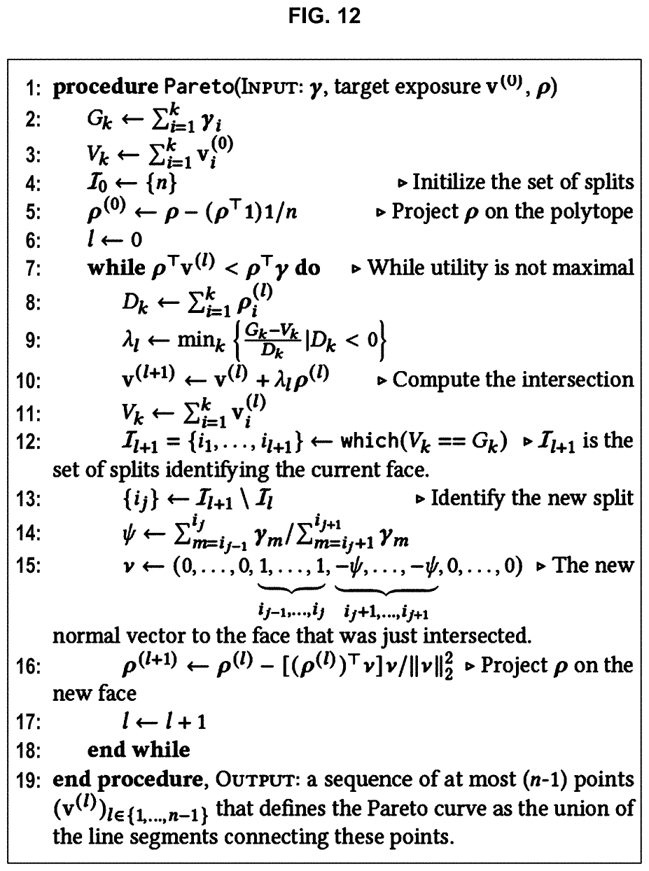

An embodiment of the Pareto-set building method is set out in FIG. 12 in pseudo code. More specifically, FIG. 12 sets forth pseudo code for Pareto-set identification, which assumes (without loss of generality) that the gain vector ρ, the vector γ of PBM parameters associated to each rank, and the initial point ν⁽⁰⁾ are in an ordered preserving zone where the values are ordered from greatest to least great.

### GLS Decomposition in the PBM-Expohedron

As set forth herein, a point in the Pareto-set, which can be chosen for instance by a decision-maker, can translate to a target exposure within the decision space. This point in the Pareto-set can be decomposed as a convex combination of at most n rankings. To begin this decomposition problem, example methods can particularize and adapt the general GLS procedure described above to the structure of the Expohedron polytope.

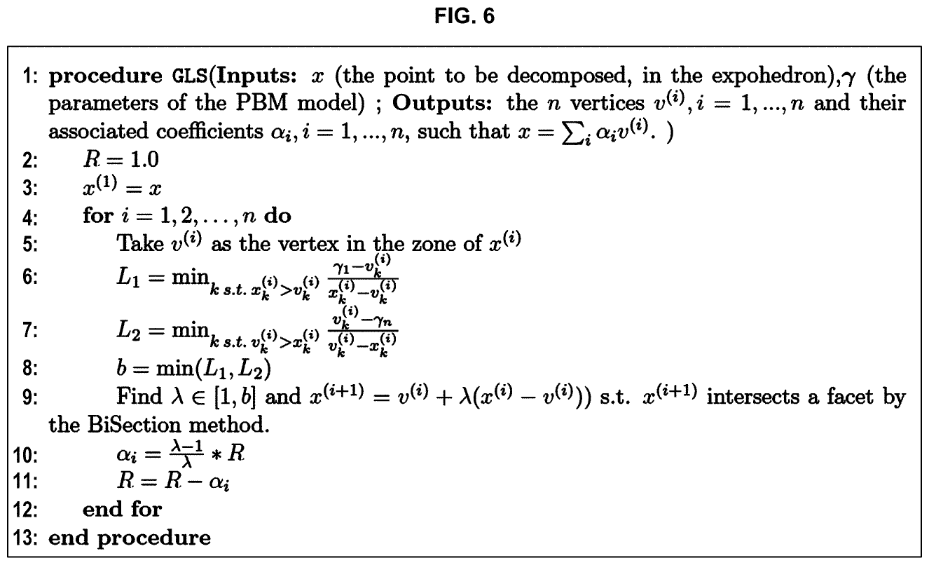

One embodiment for realizing the decomposition is set forth in pseudo-code in FIG. 6. The decomposition method in FIG. 6 exploits the fact that, once a point is on a facet (or a face of lower dimension), a vertex on this facet (or face) may be found by choosing the vertex of the zone in which the point is located, which can be done by sorting the components of the point (see line 5 in FIG. 6). Note that this step has O(n log n) complexity.

At line 9 in FIG. 6, the example method finds the point which extends the v⁽ⁱ⁾→x⁽ⁱ⁾ line segment until it reaches a facet (i.e., a face): this intersection point (x⁽ⁱ⁺¹⁾) defines the new point to be decomposed recursively. At each iteration in the loop, the new point (x⁽ⁱ⁺¹⁾) is on a face of dimension (n−i), meaning that the final point will always be a vertex (dimension=0). As finding the intersection is equivalent to finding the root of the “majorization” condition (i.e., the point where the condition value goes from True to False), at line 9 in FIG. 6 the Bisection method (i.e., a numerical method that find a root of a given function) is applied, using the majorization criterion to detect when the method should stop. In addition, the majorization criterion may be exploited to find an efficient upper end-point on the intersection with the face λ (where efficient upper end-point is used herein to mean “not too far away from the true intersection”). The computation of this endpoint is performed at lines 6-8 in FIG. 6.

The Bisection method itself has a number of iterations that is independent of n (e.g., for 5-10 iterations). Checking the majorization condition inside the Bisection method requires O(n log n) complexity, so that the total complexity of this method is O(n² log n).

### Policy Deployment Through Low-Discrepancy Sequences

Given the decomposition of the target exposure into a distribution over ranking, any of several methods, alone or in combination, may be used to deploy the distribution in the form of a sequence of rankings.

For example, stochastic sampling (i.e., random number generators) may be used to deploy a distribution over rankings. In other embodiments, Low-Discrepancy Sequences may be used (e.g., see Martin Roberts, “The unreasonable effectiveness of quasirandom sequences”, Apr 2018).

Low-Discrepancy Sequences (LDS) are provided such that for all t, the sub-sequence of rankings R₁, R₂, . . . , Rₜ has low discrepancy (i.e., the proportion of rankings is close to the desired proportion; i.e., proportion of the infinite sequence). Low-Discrepancy Sequences are typically quasi-random sequences of numbers in the [0,1] interval that are as close as possible to the uniform distribution, and these sequences of floats in [0,1] may be transformed as sequences of rankings with desired proportion by comparing the generated float with the stacked (i.e., cumulated) value of the proportions.

The use of additive-recurrence sequence based on irrational numbers (also called Kronecker, Weyl or Richtmyer sequences) may be used in embodiments, and in particular on the golden ratio, which is in some sense the most irrational number. The general recursive form of the sequence is:

sₙ₊₁=(sₙ+α) mod 1

with α=(√5−1)/2, which is the value achieving the optimal discrepancy for this additive-recurrence sequence class of LDS.

Families of efficient sampling strategies other than Low Discrepancy Sequences may alternative or additionally be used. For instance, strategies based on Stride Scheduling or, equivalently, m-balanced words, can be used as well, and can provide very similar performance.

When expressed in the terms of the example problem, a generator of m-balanced words produces a sequence of rankings such that, in any pair of sub-sequences with identical length, the frequency of any ranking differs at most by m. In other words, this generator guarantees that the generated sequence delivers the rankings with proportions as close as possible to the target ones. In theory, but not wishing to be bound by theory, the best achievable m is, in an example case, at most equal to n−1. An example algorithm capable of efficiently generating m-balanced sequences of rankings, given a certain distribution of distribution of rankings, is provided in Algorithm 1 of Shinya Sano, Naoto Miyoshi, and Ryohei Kataoka. 2004. m-Balanced words: A generalization of balanced words. Theoretical Computer Science 314, 1-2 (Feb. 2004), 97-120. https://doi.org/10.1016/j.tcs.2003.11.021. This generator is equivalent to the well-known Stride Scheduling algorithm, used to generate fair sequences in resource (CPU) management for concurrent processes, as described, for instance, in C. A. Waldspurger and E. Weihl. W. 1995. Stride Scheduling: Deterministic Proportional-Share Resource Management. Technical Report. Massachusetts Institute of Technology, USA.

### Computer Program Product

Example methods set forth for ranking objects may be provided as a computer program product comprising code instructions to execute these methods (for example using data processors 112 of the server 100 and the client devices 120), and storage means readable by computer equipment (for example using memory 113 of the server 100 and the client devices 120) provided with this computer program product for storing such code instructions.

### General

The foregoing description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure may be implemented in and/or combined with features of any of the other embodiments, even if that combination is not explicitly described. In other words, the described embodiments are not mutually exclusive, and permutations of one or more embodiments with one another remain within the scope of this disclosure. All documents cited herein are hereby incorporated by reference in their entirety, without an admission that any of these documents constitute prior art.

Each module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module. Each module may be implemented using code. The term code, as used above, may include software, firmware, and/or microcode, and may refer to programs, routines, functions, classes, data structures, and/or objects.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The systems and methods described in this application may be partially or fully implemented by a special purpose computer created by configuring a general purpose computer to execute one or more particular functions embodied in computer programs. The functional blocks, flowchart components, and other elements described above serve as software specifications, which may be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

1. A computer-implemented method for ranking a set of objects, the method comprising:
receiving the set of objects and a set of objective functions;
defining a decision space having n decision variables using a permutohedron, where n is the number of objects to rank and where vertices of the permutohedron represent permutations of exposures provided to the objects in the set by corresponding rankings;
determining a Pareto-set for the set of objective functions;
with a Pareto-optimal point in the Pareto-set, determining a distribution over rankings for the objects in the set using the decision space; where a proportion is associated to each ranking in said distribution;
selecting a sequence of rankings for the objects in the set from the distribution over rankings in accordance with their proportions; and
outputting the selected sequence of rankings.

2. The computer-implemented method according to claim 1, wherein the set of objective functions comprises a quadratic function and a linear function.

3. The computer-implemented method according to claim 2, wherein the quadratic function comprises a fairness function, and the linear function comprises a utility function.

4. The computer-implemented method according to claim 1, wherein the set of functions comprises a fairness function and a utility function.

5. The computer-implemented method according to claim 4, wherein the fairness function is a normalized function of the difference between a vector made up of the decision variables and a target vector.

6. The computer-implemented method according to claim 4, wherein the fairness function is a normalized function.

7. The computer-implemented method according to claim 6, wherein the normalized function is a squared L2-norm function.

8. The computer-implemented method according to claim 1, wherein the method further comprises:
receiving a relevance score for each object in the set, a list of exposures provided to the objects in the set which are each associated with a rank, a ranking fairness objective function, and a ranking utility objective function.

9. The computer-implemented method according to claim 8, wherein determining the Pareto-set for the set of objective functions comprises computing the Pareto-set within the decision space considering the ranking fairness objective function and the ranking utility objective function.

10. The computer-implemented method according to claim 9, wherein determining the distribution over rankings for the objects in the set using the decision space comprises:
receiving a specified point in the Pareto-set which translates to a target exposure across the objects in the set within the decision space; and
using the target exposure, determining a distribution over rankings which achieve on average the target exposure for the objects in the set, each ranking of the distribution over rankings corresponding to a vertex in the decision space.

11. The computer-implemented method according to claim 10, wherein said determining the distribution over rankings for the objects in the set using the decision space further comprises, for the number of objects in the set:
(i) determining an arbitrary vertex of the decision space;
(ii) drawing a line starting at the arbitrary vertex through the target exposure until the line intersects a face of the decision space; and
(iii) repeating (i) and (ii) on the intersected face of the decision space using the new intersection point instead of the target exposure, until the newly intersected face is a vertex;
wherein each vertex of the decision space has an associated proportion in the distribution over rankings.

12. The computer-implemented method according to claim 1, wherein the permutohedron comprises an Expohedron representing the decision space where each decision takes a form of a ranking policy π(q) that is a distribution over m rankings with m≤n σᵢ (i=1, . . . , m):
π(q)=Σᵢ₌₁^{m}αᵢσᵢ,
where each ranking σᵢ maps each object dⱼ to a rank σᵢ(dⱼ), and where αᵢ is the proportion of ranking σᵢ in π(q).

13. The computer-implemented method according to claim 1, wherein the set of functions comprises a fairness function and a utility function;
wherein the fairness function is based on Meritocratic fairness.

14. The computer-implemented method according to claim 1, wherein the set of functions comprises a fairness function and a utility function;
wherein the fairness function is based on Demographic fairness.

15. The computer-implemented method according to claim 1, wherein said determining the distribution over rankings for the objects in the set using the decision space uses a GLS procedure.

16. The computer-implemented method according to claim 1, wherein said selecting a sequence of rankings for the objects in the set comprises one or more of stochastic sampling, Low-Discrepancy Sequences, additive-recurrence sequences, Stride Scheduling, or m-balancing.

17. The computer-implemented method according to claim 1, wherein the objects in the set comprise a plurality of queries.

18. The computer-implemented method according to claim 1, wherein the objects in the set comprise a plurality of documents.

19. The computer-implemented method according to claim 1, wherein the objects in the set are identified in response to a query.

20. The computer-implemented method according to claim 1, wherein the objects in the set comprise a plurality of recommendations.

21. The computer-implemented method according to claim 20, wherein the objects in the set are identified in response to a map location.

22. The computer-implemented method according to claim 1, wherein said outputting comprises
providing for display on a display of a device at least a subset of the set of objects, ranked according to the selected sequence of rankings.

23. The computer-implemented method according to claim 1, wherein the at least a subset of the set of objects is provided on a Search Engine Result Page.

24. A computer program product comprising non-transitory machine-readable instructions stored on a tangible medium which, when said instructions are executed on a computer, cause the computer to perform a method comprising:
receiving a set of objects and a set of objective functions;
defining a decision space having n decision variables using a permutohedron, where n is the number of objects to rank and where vertices of the permutohedron represent permutations of exposures provided to the objects in the set by corresponding rankings;
determining a Pareto-set for the set of objective functions;
with a Pareto-optimal point in the Pareto-set, determining a distribution over rankings for the objects in the set using the decision space; where a proportion is associated to each ranking in said distribution;
selecting a sequence of rankings for the objects in the set from the distribution over rankings in accordance with their proportions; and
outputting the selected sequence of rankings.

25. A data processing device comprising a processor configured to perform a method, the method comprising:
receiving a set of objects and a set of objective functions;
defining a decision space having n decision variables using a permutohedron, where n is the number of objects to rank and where vertices of the permutohedron represent permutations of exposures provided to the objects in the set by corresponding rankings;
determining a Pareto-set for the set of objective functions;
with a Pareto-optimal point in the Pareto-set, determining a distribution over rankings for the objects in the set using the decision space; where a proportion is associated to each ranking in said distribution;
selecting a sequence of rankings for the objects in the set from the distribution over rankings in accordance with their proportions; and
outputting the selected sequence of rankings.

26. The data processing device of claim 25, wherein the data processing device is incorporated in a second-stage ranker for a two-stage information retrieval system.

27. The data processing device of claim 25, wherein the data processing device comprises a server.

28. The data processing device of claim 25, wherein the data processing device comprises a client.

29. A system for information retrieval comprising:
a computer-implemented first-stage retriever configured to receive a query and generate a set of objects; and
a computer-implemented second-stage ranker configured to:
receive the set of objects and a set of objective functions;
define a decision space having n decision variables using a permutohedron, where n is the number of objects to rank and where vertices of the permutohedron represent permutations of exposures provided to the objects in the set by corresponding rankings;
determine a Pareto-set for the set of objective functions;
with a Pareto-optimal point in the Pareto-set, determine a distribution over rankings for the objects in the set using the decision space; where a proportion is associated to each ranking in said distribution;
select a sequence of rankings for the objects in the set from the distribution over rankings in accordance with their proportions; and
output the selected sequence of rankings.

30. The system of claim 29, wherein said outputting comprises providing for display on a display of a device at least a subset of the set of objects, ranked according to the selected sequence of rankings.

31. The system of claim 30, wherein the at least a subset of the set of objects is provided in a Search Engine Result Page for display on a display of a server or a client device.
